(19) United States
(12) Patent Application Publication
(10) Pub. No.: US 2026/0017502 A1
(43) Pub. Date: Jan. 15, 2026

(54) MODEL QUANTIZATION IMPLEMENTATION METHOD, BUSINESS PROCESSING METHOD AND RELATED APPARATUS

(71) Applicant: Smarter Silicon (Shanghai) Technologies Co., Ltd., Shanghai (CN)

(72) Inventor: Feifei FANG, Shanghai (CN)

(21) Appl. No.: 19/267,525

(22) Filed: Jul. 12, 2025

(30) Foreign Application Priority Data
Jul. 12, 2024 (CN) 202410941229.9

(51) Int. Cl. G06N 3/0495; G06N 3/045; G06Q 10/067

(52) U.S. Cl. CPC G06N 3/0495; G06N 3/045; G06Q 10/067

(57) ABSTRACT

A model quantization implementation method includes obtaining an initial neural network model, the initial neural network model including a plurality of initial neural network layers, the initial neural network model being obtained by performing quantization perception training based on a training data set; performing a quantization configuration update operation to determine the quantization configuration of each of the initial neural network layers, determining at least one target neural network layer in the initial neural network model based on the characteristic parameter deviation, and determining different quantization configurations corresponding to at least one target neural network layer and other initial neural network layers in the initial neural network model; and, performing quantization awareness training on the initial neural network model to obtain a target neural network model based on the determined quantization configuration and the training data set.

### CROSS-REFERENCES TO RELATED APPLICATION

This application claims priority to Chinese Patent Application No. 202410941229.9 filed on Jul. 12, 2024, the entire content of which is incorporated herein by reference.

### FIELD OF TECHNOLOGY

The present disclosure relates to the field of artificial intelligence technology and, more specifically, to a model quantization implementation method, a business processing method and related apparatus.

### BACKGROUND

In recent years, neural network models based on deep learning have been widely used in many fields. As the performance of models improves, a huge number of parameters and calculations are introduced. In response to this, model quantization technology has developed, which is a technology that converts floating-point calculations into low-bit fixed-point calculations. It can effectively reduce the model's calculation intensity, parameter size, and memory consumption, and improve the model's running speed.

However, in the actual model quantization process, all neural network layers of the neural network model are generally uniformly quantized and converted to use the quantized neural network model to perform business operations. This can easily cause a loss in the quantization accuracy of the neural network model, resulting in an inability to meet business needs.

### SUMMARY

One aspect of this disclosure provides a model quantization implementation method. The method includes obtaining an initial neural network model, the initial neural network model including a plurality of initial neural network layers, the initial neural network model being obtained by performing quantization perception training based on a training data set, and performing a quantization configuration update operation to determine the quantization configuration of each of the initial neural network layers. Performing the quantization configuration update operation to determine the quantization configuration of each of the initial neural network layers includes quantizing different initial neural network layers to obtain reference neural network models corresponding to the quantized initial neural network layers, obtaining a characteristic parameter deviation of at least one target characteristic after each reference neural network model processes the training data set, determining at least one target neural network layer in the initial neural network model based on the characteristic parameter deviation, and determining different quantization configurations corresponding to at least one target neural network layer and other initial neural network layers in the initial neural network model. The method further includes performing quantization awareness training on the initial neural network model to obtain a target neural network model based on the determined quantization configuration and the training data set.

Another aspect of this disclosure provides a business processing method. The method includes obtaining a business request, the business request including to-be-processed business data, calling a target neural network model to process the business data to obtain a business processing result, and outputting the business processing result. The target neural network model is obtained by performing quantization perception training of at least two different quantization configurations.

Another aspect of this disclosure provides an electronic device. The electronic device includes one or more first processors and one or more first memories coupled to the one or more first processors and storing a plurality of first computer instructions that, when being executed, cause the one or more first processors to obtain an initial neural network model, the initial neural network model including a plurality of initial neural network layers, the initial neural network model being obtained by performing quantization perception training based on a training data set, and perform a quantization configuration update operation to determine the quantization configuration of each of the initial neural network layers. Perform the quantization configuration update operation to determine the quantization configuration of each of the initial neural network layers includes quantize different initial neural network layers to obtain reference neural network models corresponding to the quantized initial neural network layers, obtain a characteristic parameter deviation of at least one target characteristic after each reference neural network model processes the training data set, determine at least one target neural network layer in the initial neural network model based on the characteristic parameter deviation of at least one target characteristic corresponding to each of the quantized initial neural network layers, the target neural network layer being the quantized initial neural network layer corresponding to the characteristic parameter deviation that meets a preset condition, determine different quantization configurations corresponding to at least one target neural network layer and other initial neural network layers in the initial neural network model. The one of more first processors are further configured to perform quantization awareness training on the initial neural network model to obtain a target neural network model based on the determined quantization configuration and the training data set.

Another aspect of this disclosure provides a business device. The business device includes one or more second processors and one or more second memories coupled to the one or more second processors and storing a plurality of second computer instructions that, when being executed, cause the one or more second processors to obtain a business request, the business request including to-be-processed business data, call a target neural network model to process the business data to obtain a business processing result, and output the business processing result. The target neural network model is obtained by quantization perception training of at least two different quantization configurations.

### BRIEF DESCRIPTION OF THE DRAWINGS

In combination with accompanying drawings and with reference to the following description of embodiments, the above and other features, advantages and aspects of the embodiments of the present disclosure will become more apparent. Throughout the drawings, a same or similar reference number represents a same or similar element. It should be understood that the drawings are schematic and that an element are not necessarily drawn to scale.

FIG. 1 is a schematic diagram of the hardware structure of an electronic device suitable for a model quantization implementation method according to some embodiments of the present disclosure.

FIG. 2 is a schematic diagram of the hardware structure of the electronic device suitable for the model quantization implementation method according to some embodiments of the present disclosure.

FIG. 3 is a schematic diagram of a system architecture for an application scenario of a business processing method according to some embodiments of the present disclosure.

FIG. 4 is a flowchart of the model quantization implementation method according to some embodiments of the present disclosure.

FIG. 5 is a flowchart of the model quantization implementation method according to some embodiments of the present disclosure.

FIG. 6 is a flowchart of the model quantization implementation method according to some embodiments of the present disclosure.

FIG. 7 is a flowchart of the business processing method according to some embodiments of the present disclosure.

FIG. 8 is a schematic diagram of the structure of a model quantization implementation device according to some embodiments of the present disclosure.

FIG. 9 is a schematic diagram of the structure of a business processing device according to some embodiments of the present disclosure.

### DETAILED DESCRIPTION

Technical solutions of the present disclosure will be described in detail with reference to the drawings. It will be appreciated that the embodiments described represent some, rather than all, of the embodiments of the present disclosure. Other embodiments conceived or derived by those having ordinary skills in the art based on the described embodiments without inventive efforts should fall within the scope of the present disclosure.

In the specification, claims, and accompanying drawings of this disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having the same attribute in embodiments of this disclosure. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, system, product, or device.

The present disclosure can be applied to the fields of image/speech/text data processing, such as image denoising, speech enhancement, text recognition and other application scenarios to meet the corresponding business data processing needs. The present disclosure can be, but is not limited to, applied to applications with data processing functions (such as image processing software or audio processing software, etc.) or cloud services provided by cloud-side servers, etc., which can be determined based on actual needs.

For example, when running image processing software on an electronic device, the trained target neural network model can be called to perform denoising on the original image. The target neural network model can be obtained by performing quantization perception training on the initial neural network model used to implement image denoising based on the model quantization implementation method provided in the embodiments of the present disclosure. In this way, the colors before and after image processing are consistent, which improves the quality of the processed image and the color fineness and avoids color distortion.

Similarly, for other types of data processing software such as audio, video or text running on electronic devices, the target neural network model used to process the corresponding type of raw data can also be obtained by first performing quantization perception training on the initial neural network used to process the data based on the model quantization implementation method provided in the embodiments of the present disclosure. For the implementation process, reference can be made to the description of the corresponding part of the method embodiment below, which will not be repeated here. Of course, for other business services or data processing services and other types of business services based on cloud services, after obtaining the initial neural network model for implementing the business service, the model quantization implementation method provided in the embodiments of the present disclosure can still be used to accurately weigh the quantization accuracy and quantization range during the quantization perception training of the initial neural network model. In this way, the quantization quality of the target neural network model can be improved, thereby improving the business performance of processing the corresponding type of business based on the target neural network model.

It should be noted that the neural network model described in the embodiments of the present disclosure may be a mathematical calculation model that imitates the behavioral characteristics of the human brain neural network and performs distributed parallel information processing, and can generally include a variety of neural network layers with different functions (such as convolutional layers for feature extraction, etc.). Each layer contains a large number of parameters and calculation formulas, or is composed of a combination of multiple existing neural network sub-models. Neural network models can be used to realize artificial intelligence (AI) technology. There are many different AI models (such as neural network models) used in AI technology. Different application scenarios (such as classification scenarios or recognition scenarios, etc.) can use AI models with different structures. The present disclosure does not limit the type of neural network model and its network structure involved in each embodiment.

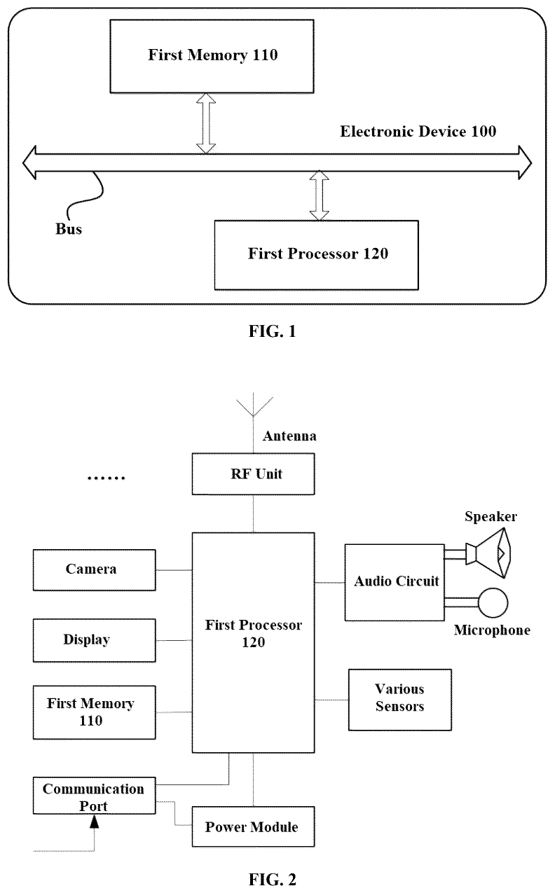

FIG. 1 is a schematic diagram of the hardware structure of an electronic device 100 suitable for a model quantization implementation method according to some embodiments of the present disclosure. The electronic device 100 may be a server or a terminal device. The server may be one or more servers, such as a physical server or a cloud server. The Terminal devices may include, but is not limited to, a smartphone, a tablet, a wearable device, a personal computer (PC), a smart watch, an augmented reality (AR) device, a virtual reality (VR) device, a vehicle-mounted device, smart speakers, robots or smart medical/transportation equipment, etc. The present disclosure does not limit the product form of the electronic device 100.

The following description takes the electronic device 100 as a server as an example. As shown in FIG. 1, the electronic device 100 may include at least one first memory 110 and at least one first processor 120. The at least one first memory 110 and the at least one first processor 120 may communicate with each other via a bus. The bus may be a peripheral component interconnect (PCI) bus or an extended industry standard architecture (EISA) bus. The bus may be divided into an address bus, a data bus, a control bus, etc. For ease of representation, only one thick line is used in FIG. 1 to represent the bus, but this does not mean that there is only one bus or one type of bus.

The first memory 110 can be used to store computer instructions and data, and can include an instruction storage area and a data storage area. The data storage area can store various data, such as the initial neural network model, training data set, and various intermediate data generated during the model quantization implementation process. The instruction storage area can store software units such as operating systems, applications, and computer instructions required for at least one function (such as image/audio data processing functions). In the embodiments of the present disclosure, the first memory 110 may be configured to provide the first processor 120 with a plurality of computer instructions for implementing the model quantization implementation method of the embodiments of the present disclosure, as well as data or other software and hardware resources required during the execution of the model quantization implementation method.

The first processor 120 can serve as the control center of the electronic device and can connect various parts of the entire electronic device using various interfaces and lines. By loading and executing multiple computer instructions stored in the memory, each step of the model quantization implementation method provided in the embodiments of the present disclosure can be implemented. For the implementation process, reference can be made to the description of the corresponding part of the method embodiment below. Other components of the electronic device (such as communication components, one or more input components and output components, etc.) can also be called to implement the corresponding functions.

In some embodiments, the first memory 110 may include a volatile memory, such as a random-access memory (RAM), and may also include a non-volatile memory (non-volatile memory), such as a read-only memory (ROM), a flash memory, a hard drive drive (HDD) or a solid state drive (SSD). The first processor 120 may include any one or more of a central processing unit (CPU), a graphics processing unit (GPU), a microprocessor (MP), a digital signal processor (DSP), an application specific integrated circuit (ASIC), or a field programmable gate array (FPGA). The present disclosure does not limit the types of the first memory 110 and the first processor 120 and their working principles, and they can be flexibly configured based on actual needs.

It should be understood that the structure of the electronic device shown in FIG. 1 does not limit the electronic device in the embodiments of the present disclosure. In actual applications, the electronic device may include more or fewer components than those shown in FIG. 1, or may combine certain components. In some embodiments, when the electronic device is a terminal device, as shown in FIG. 2, the electronic device 100 may also include at least one input component such as a touch sensing unit for sensing a touch event on a touch display panel, a keyboard, a mouse, a camera, a pickup, etc.; at least one output component such as a display, speaker, vibration mechanism, indicator light, etc.; an antenna, a radio frequency (RF) unit, various sensors, a power module, etc. FIG. 2 does not show the listed components. The hardware structure can be determined based on the terminal device type and its functional requirements, and the present disclosure does not list them here.

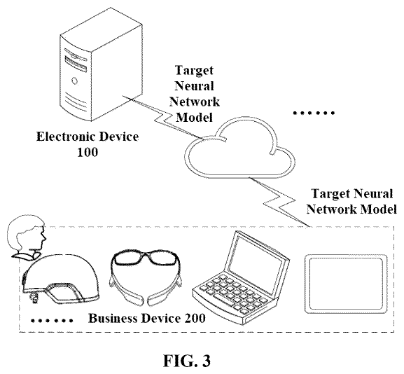

The target neural network model for business data processing in the corresponding business scenario can be obtained by executing the model quantization implementation method provided in the embodiments of the present disclosure for the electronic device 100. The electronic device 100 or other business device 200 can implement each step of the business processing method provided in the embodiments of the present disclosure based on the target neural network model, thereby ensuring high reliability and accuracy of the business processing results and better meeting the corresponding business needs. The following is an example of a scenario in which a business device 200 different from the electronic device 100 described above implements the business processing method provided in the embodiments of the present disclosure. FIG. 3 is a schematic diagram of a system architecture for an application scenario according to some embodiments of the present disclosure. The system may include at least one electronic device 100 and at least one business device 200. The business device 200 can be connected to the electronic device 100 for communication (such as a wireless network communication connection shown in FIG. 3 or a wired network communication connection mode can also be adopted. The present disclosure does not limit the communication connection method between different devices). The business device can call or obtain the target neural network model in the electronic device 100 for implementing the corresponding business data processing, and execute each step of the business processing method provided in the present disclosure. It should be noted that FIG. 3 is merely an example system architecture disclosed in the present disclosure, and does not constitute a limitation on the product form of the device composition of the system architecture.

In some embodiments, the business device 200 provided in the embodiments of the present disclosure may include at least one second memory and at least one second processor. For the component types and connection methods of the business device 200, reference can made to the description of the component types and connection methods of the first memory 110 and the first processor 120 included in the electronic device 100 shown in FIG. 1 above. The present disclosure does not describe the connection method and type between the second memory and the second processor in detail. The second processor can be used to load and execute the plurality of second computer instructions stored in the second memory to implement the steps of the business processing method provided in the embodiments of the present disclosure. For the implementation process, reference can be made to the description of the corresponding part of the business processing method embodiment below.

In some embodiments, to realize the communication connection between the business device 200 and the electronic device 100, the two devices may include corresponding communication ports, which may include communication components corresponding to wireless communication methods such as Wi-Fi, 5G/6G, GPRS communication, Bluetooth and/or near-field channel. In this way, the business device 200 can realize data transmission between the electronic device 100 through wireless communication, such as transmission of target neural network model or business data, etc. The electronic device 100 and/or the business device 200 may also include one or more interfaces that support wired communication, such as a general-purpose input/output (GPIO) interface, a USB interface, a universal asynchronous receiver/transmitter (UART) interface, etc. to realize data transmission between carious components of the electronic device and/or the business device. The communication port can realize connection with other components inside the corresponding device through a bus, etc. The present disclosure does not limit the communication transmission mechanism between the electronic device 100 and the business device 200, which can be determined based on the actual needs.

It should be understood that, when the business device 200 is a terminal device as shown in FIG. 3 (which can also include an independent terminal, an access control device or other monitoring devices in various industries, and is not limited to the product forms of the terminal device shown in FIG. 3 and listed above), refer to the schematic structural diagram of the terminal device shown in FIG. 2, the business device may further include one or more input components, one or more output component, etc., which can be determined based on the business requirements of the business terminal 200, and the present disclosure will not list these components here.

In view of the above description of the electronic device 100 and its composition structure provided in the embodiments of the present disclosure, in order to improve the quantization accuracy and operation efficiency of the neural network model and reliably and quickly meet business needs, the embodiments of the present disclosure provide a model quantization implementation method. The model quantization implementation method will be described in detail below in conjunction with the accompanying drawings.

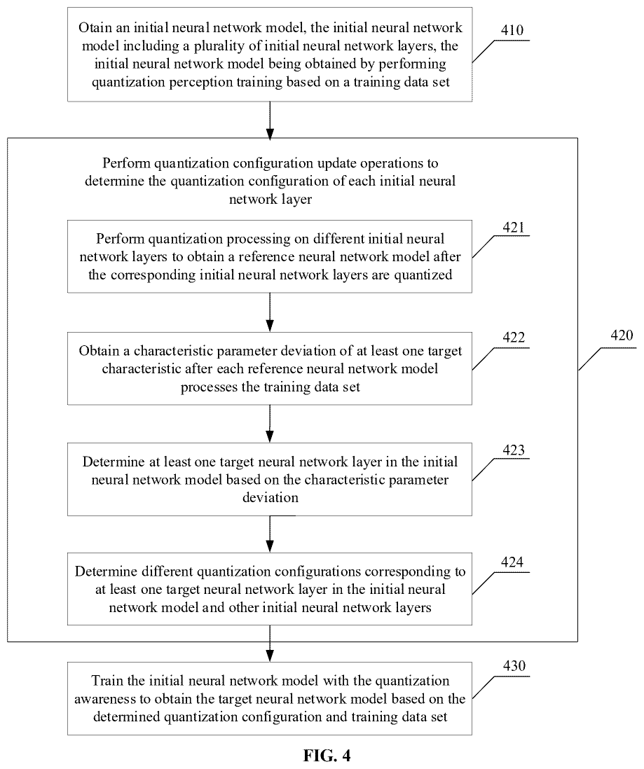

FIG. 4 is a flowchart of the model quantization implementation method according to some embodiments of the present disclosure. The method can be applied to the electronic device 100 described above. The method will be described in detail below.

410, obtaining an initial neural network model, the initial neural network model including a plurality of initial neural network layers, the initial neural network model being obtained by performing quantization perception training based on a training data set.

As described above, for neural network models suitable for business scenarios (such as classification or recognition scenarios), such as image segmentation network models, target recognition models, speech enhancement models or text classification models, the large number of high-precision floating-point parameters often lead to high memory footprint, high power consumption and high latency, which limits the range of operation equipment and reduces business processing efficiency. Therefore, there is a need to quantize high-precision floating-point parameters such as model weights and activation values into low-precision fixed-point parameters through model quantization such that the quantized model can occupy less memory overhead, speed up inference, and better meet business processing needs. In the embodiments of the present disclosure, the model quantization can be realized during the model training process. A floating-point model, i.e., an initial neural network model, can be first constructed and trained, and then the quantization parameters can be determined by subsequent quantization training methods to achieve the purpose of model quantization, thereby avoiding the adverse effects of the quantization range being too large or the quantization accuracy being too high, which affect the overall performance of the model (processing accuracy or running speed).

In the process of building and training a floating-point model, a neural network that has been built and is suitable for the business scenario (such as an initial neural network built based on an adapted deep learning algorithm) may be obtained or an initial neural network for the actual business scenario may be built. After obtaining the training data set for the business scenario (such as image datasets for image processing scenarios, speech datasets for speech processing scenarios, or text datasets for text recognition scenarios, the present disclosure does not limit the data types and acquisition methods of the training datasets, which includes but is not limited to datasets from various open source datasets), a quantization-aware training (QAT) method can be used to train the quantifiable initial neural network model. The present disclosure does not elaborate on the implementation of quantization-aware training based on the training data set.

In some embodiments, the model can be training in PyTorch (an open-source Python machine learning library) by simulating the quantization process to ensure that the model still maintains good performance after quantization. The model parameters of the initial neural network model of the embodiments of the present disclosure may still be floating point parameters. In order to truly reduce the storage requirements and computational complexity of the model, there is a need perform quantization training based on the method described below to convert the floating-point model into a fixed-point model to support its use on low-precision computing hardware, and ensure the high performance of the model.

In some embodiments, the benchmark QAT process performed in PyTorch may include using the same type of observer to simulate the global quantization of the model during model training and determine the global initial quantization configuration that improves the operating efficiency and minimizes the loss of quantization accuracy. For example, the moving max min observer can be used to perform two rounds (or three rounds or fewer) of QAT initialization training. Then LSQ or LSQ+ (learned step size quantization, i.e., neural network low-bit quantization) quantization training can be performed on each neural network layer to obtain the initial neural network model corresponding to the training convergence. The observer is an entity or mechanism used to observe and record model behavior or performance. It is a tool used to collect model output data, calculate performance indicators, or monitor model runtime. Its observations are used to evaluate the accuracy, efficiency, or other relevant performance indicators of the model. The present disclosure does not elaborate on the working process of different types of observers under the model quantization architecture.

It should be noted that the global quantization observer type in the benchmark QAT process may also be one of the max min observer, the moving average observer, the percentile observer, the mean square error (MSE) observer, the Kullback Leibler (KL) observer, and the mix observer. In the embodiments of the present disclosure, the appropriate type of observer can be selected for simulation quantization based on the performance differences (such as one or more of accuracy, time consumption, and parameter adjustment complexity) between different types of observers. The present disclosure does not describe the quantitative performance and implementation process of each type of observer in detail.

In addition, the present disclosure does not limit the type of initial neural network model and its network structure, including but not limited to classification/recognition network models used for classification tasks or recognition tasks of various business data, etc. The same or similar benchmark QAT process can be used to simulate the effect of quantization during the training process to realize the initial configuration of the model quantization processing and obtain the floating-point initial neural network model. The present disclosure does not describe the quantization perception training process of the benchmark QAT process in detail. It is understandable that, combined with the above description of the neural network model, the initial neural network model may include a plurality of initial neural network layers, such as one or more convolutional layers, pooling layers, activation layers, and fully connected layers. The number of initial neural network layers and the functions of each layer of the initial neural network can be determined based on actual business processing requirements.

420, performing quantization configuration update operations to determine the quantization configuration of each initial neural network layer. The process at 420 may include processes 421-424.

Following the above analysis, in the process of model quantization implementation, if the number of quantized bits is too high, the model's memory overhead, power consumption and latency will increase, and the model may not be used on low-precision hardware devices. If the initial neural network layers contained in the initial neural network model are directly quantized globally, it can cause the model quantization accuracy to drop due to the large quantization range and fail to meet business processing requirements. Therefore, under the limitation of the number of quantization bits, there is a need to reasonably balance the quantization accuracy and quantization range to ensure the performance of the quantized model and reliably meet business processing requirements.

Take the initial neural network model suitable for image processing tasks as an example to illustrate the technical problems in the model quantization process. If the initial neural network model is a neural network model built based on the super-resolution algorithm, after image super-resolution occurs during the same quantization conversion process for each neural network layer, the saturation of highly saturated colors in the image is reduced due to the limitation of the quantization range, or the color richness of the image in areas with frequency color changes is reduced due to the limitation of quantization accuracy, that is, the image processed by the quantized model has color difference, which reduces the image quality. Even if the loss of precision is compensated by using pure color images, chromatic aberration cannot be reliably eliminated. If a higher number of quantization bits is used, although the color fineness can be improved, it will affect the image processing efficiency due to increased memory usage, power consumption and delay.

To further improve the model quantization process, in the present disclosure, the initial neural network model can adopt different quantization configurations globally to correspond to different types of observers to achieve different quantization of the initial neural network layers of the corresponding layers, thereby avoiding the overall performance of the model being too low due to inappropriate quantization range and quantization accuracy. Based on this, in the present disclosure, quantization sensitive layer analysis can be performed on the initial neural network model to determine which initial neural network layers are sensitive layers that need to be corrected for simulated quantization configuration (which can be referred to as the target neural network layers), and what quantization configuration the sensitive layers have such that the sensitive layers can be adjusted to the appropriate quantization range to improve quantization accuracy to reduce the impact on the overall performance of the quantized neural network model.

For the screening of at least one sensitive layer in the initial neural network model, at least one initial neural network layer can be manually selected as a sensitive layer for quantitative testing. That is, the floating-point parameters of the initial neural network model can be quantized through the observers corresponding to different quantization configurations, and the appropriateness of each selection of the sensitive layer can be determined based on the quantization accuracy test. However, this manual repeated trial and error method is too costly, and the quantization range corresponding to the sensitive layer screened out may not be the most appropriate. It is easy to have problems such as the quantization range being too large, leading to excessive loss of accuracy. Therefore, the processes at 421-424 can be used to automatically perform quantization configuration update operations on the initial neural network model, and quickly and accurately obtain at least one target neural network layer (i.e., sensitive layer) of the quantization configuration that needs to be updated and initialized and its updated quantization configuration. In this way, the impact on the overall performance of the model is reduced by performing quantization training, and higher quantization accuracy within an appropriate quantization range can be obtained.

It should be noted that the updated quantization configuration of at least one target neural network layer determined during the quantization configuration update operation, i.e., the updated observer, can optimize the overall performance of the model relative to the initial observer used for the simulated quantization of the initial neural network model in the benchmark QAT process, such as achieving one or more of shorter time consumption, higher quantization accuracy, and lower parameter complexity. The observer type for the target neural network layer's quantization configuration update can be flexibly selected based on the initial observer type and the performance differences between different observer types. The present disclosure does not restrict the observer types used/determined in the execution stages of different steps in the model quantization implementation method.

421, performing quantization processing on different initial neural network layers to obtain a reference neural network model after the corresponding initial neural network layers are quantized.

Continue with the above analysis, to determine which one or more initial neural network layers contained in the initial neural network model are suitable as the target neural network layer, different initial neural network layers in the initial neural network model can be quantized, and the neural network model with at least one neural network layer corresponding to the quantized processing can be recorded as the reference neural network model such that multiple reference neural network models can be obtained. Different reference neural network models may contain at least one neural network layer that is different or not completely the same after quantization. That is, the number or position of quantized neural network layers contained in different reference neural network models can be different such that each reference neural network model has a different quantization range, thereby automatically testing and obtaining the target neural network layer corresponding to the appropriate quantization range. The present disclosure does not describe the process of obtaining each reference neural network model in detail.

In some embodiments, the quantization processing of any initial neural network layer in the initial neural network model can be a quantization conversion processing that reduces the high precision (i.e., floating point numbers) of the weights and activation values of the initial neural network layer to lower precision (i.e., fixed point numbers). The present disclosure does not describe the quantization conversion processing method in detail. The initial neural network layer that has not been quantized can be directly used as the corresponding neural network layer in the corresponding reference neural network model such that the impact of the quantized neural network layer on the performance of the entire model can be accurately determined later.

422, obtaining a characteristic parameter deviation of at least one target characteristic after each reference neural network model processes the training data set.

Based on the above description of each reference neural network model, different reference neural network models can have different quantization ranges. The influence of different quantization ranges and quantization accuracy can be automatically analyzed to determine the sensitive layer in the initial neural network model. That is, at least one target neural network layer needs to update the quantization configuration. Therefore, in the present disclosure, the performance of the corresponding reference neural network model can be evaluated based on the characteristic parameter deviation of at least one target characteristic after each reference neural network model processes the training data set, thereby determining the influence of the corresponding quantization range on the model quantization accuracy, and selecting the neural network layer corresponding to the quantization range with greater influence. In some embodiments, the target characteristic can be the characteristic of the training data that will be affected when the reference neural network model processes the training data set. The characteristic type can be determined based on the data type of the training data set. The present disclosure does not limit the characteristic type of the at least one target characteristic.

For example, if the training data set is a training image set, each neural network model can be a neural network model suitable for image processing (such as image segmentation, target object recognition or image denoising, etc.), after obtaining the corresponding reference neural network model based on the quantization configuration update operation described above, the images in the training image set can be input into the reference neural network model to obtain the characteristic parameter deviation of at least one target characteristic between its output image (i.e., the processed image) and the input image (i.e., the image in the training image set). The characteristic parameter deviation may be a color deviation, a brightness deviation, a texture deviation or a shape deviation, and the corresponding target characteristic can be a color characteristic, a brightness characteristic, a texture characteristic and a shape characteristic, and can be based on the high-precision characteristics required by the actual business scenario.

Similarly, if the training data set is a training speech data set, after obtaining any reference neural network model described above, the speech data can be input into the reference neural network model for speech enhancement processing, and obtain the characteristic parameter deviation of one or more target characteristics (which can ensure that the speech before and after the reference neural network model processing is not distorted) such as the pitch characteristics, tone weight, speech speed and timbre between the enhanced speech data and the original input speech data, thereby determining the image processing performance of the reference neural network model. If the training data set is a text data set, the text data can be processed based on any reference neural network model to obtain the characteristic parameter deviation of one or more target characteristics in the text type, text element and text structure of the text data before and after processing, thereby determining the processing performance of the reference neural network model on the text data.

In some embodiments, the characteristic parameter deviation of each target characteristic of the training data set of different categories can be determined based on the characteristic category of the corresponding target characteristic and its impact on the model processing performance. The present disclosure does not describe the method for obtaining the characteristic parameter deviation amount of each category of target characteristics in detail. For example, the target characteristic may be a color characteristic, and the characteristic parameter deviation may be the color difference of the same pixel between the input image and the processed output image.

423, determining at least one target neural network layer in the initial neural network model based on the characteristic parameter deviation.

In some embodiments, the target neural network layer may be the quantized initial neural network layer corresponding to the characteristic reference deviation layer that meets the preset conditions. Based on the process at 422, the performance test of each reference neural network model with different quantization ranges, i.e., the quantization accuracy test, can characterize the adverse effect (i.e., accuracy loss) of the corresponding quantization range of the initial neural network model on the quantization accuracy through the characteristic parameter deviation of at least one target characteristic corresponding thereto. In this way, by analyzing the changes in the quantization accuracy of reference neural network models with multiple different quantization ranges, the quantization range of the initial neural network model having a greater impact on the quantization accuracy can be determined. Therefore, a reference neural network model with a larger quantization range can be quickly and reliably selected, which has at least one higher-level quantized neural network layer, and the initial neural network layer of the corresponding layer in the initial neural network model is determined as the target neural network layer to facilitate the quantization training method described at the process at 423. In this way, the relatively large quantization range can be adjusted to a smaller and more appropriate quantization range to ensure that the quantization accuracy of the quantized neural network model is sufficient and not too high (that is, it can meet the business processing requirements), thereby realizing an automatic and reasonable trade-off between the quantization range and quantization accuracy of the initial neural network model. In this way, the issues of manual repeated attempts to select the target neural network layer being costly and determined quantization range being inappropriate are addressed.

424, determining different quantization configurations corresponding to at least one target neural network layer in the initial neural network model and other initial neural network layers.

Based on the steps described above, after automatically selecting at least one target neural network layer corresponding to the quantization range with a relatively great impact on the model quantization accuracy (i.e., the characteristic parameter deviation of at least one target characteristic of the processed data with a relatively great impact) from the plurality of initial neural network layers contained in the initial neural network model, automatically select at least one target neural network, to ensure the overall performance of the neural network model after quantization, compared with updating the global quantization configuration, in the present disclosure, the initial quantization configuration of the initial neural network model simulation quantization can be locally updated. That is, the quantization configuration of the at least one target neural network layer is updated to be different from the quantization configuration of other initial neural network layers (i.e., each initial neural network layer except the target neural network layer) in the initial neural network model. For example, at least one target neural network layer may correspond to a first quantization configuration, and the other initial neural network layers may correspond to a second quantization configuration. The present disclosure does not limit the observer types corresponding to different quantization configurations and their quantization implementation methods.

Referring to the various types of observers listed above, the max min observer is a simple observer that only needs to track the maximum and minimum activation values during training. The parameter adjustment complexity is very low and the time consumption is very small. The moving max min observer is an improved version of the max min observer. It uses exponential moving average (EMA) to smoothly update the maximum and minimum values, which can provide higher accuracy than max min observer. Therefore, in some embodiments, if the global observer used for quantization simulation during model training in step at 410 through the benchmark QAT process is the moving max min observer, in the present disclosure, the quantization configuration of at least one target neural network layer can be updated to the max min observer, and the quantization configuration of other initial neural network layers can remain as the moving max min observer. Compared with directly turning off the quantization of the target neural network layer or still using the original moving max min observer, or globally updating to the max min observer, the technical solutions provided in the present disclosure can minimize the impact on the overall performance of the neural network model through a suitable quantization range, maintain higher quantization accuracy, and better meet business processing needs.

It should be noted that when the initialized observer is the moving max min observer, the quantization configuration for updating at least one target neural network layer may also be other types of observers that can improve the quantization accuracy, such as the mix observer. By using only the output similarity of an operator as an evaluation index when searching for the quantization parameter of an operator, the optimal quantization parameter, i.e. the quantization parameter with the smallest error before and after quantization and dequantization, can be identified, which has higher quantization accuracy. If the initialized observer is another type of observer, such as the MSE observer, the moving step size of the sliding window on the input data in the convolution operation can be adjusted, which has higher quantization accuracy but is very time-consuming. The quantization configuration for the target neural network layer updates can be the max min observer/moving max min observer to increase the quantization speed to realize the technical effect of the above quantization model. However, the observer types are not limited to the observer types in the scheme of using different types of observers for different neural network layers in the same neural network model listed in this embodiment, and can be flexibly set based on actual needs.

In addition, for the initialized global quantization configuration, different types of observers may also be used for model weights and activation values. When updating the quantization configuration of the target neural network layer, at least one of the different initialization observers corresponding to the model weights and activation values can be updated to another type of observer such that different observers corresponding to different initial neural network layers can complete the model quantization training. That is, the high-precision floating-point parameters such as model weights and activation values can be converted into low-precision fixed-point parameters. Compared with global initialization observer or global update observer for model quantization, the technical solutions of the present disclosure can reduce the loss of quantization accuracy and ensure the quality of model output at a higher operating efficiency. Of course, the present disclosure can also update the quantization configurations corresponding to the target neural network layer and other initial neural network layers to other different quantization configurations that are different from the initial quantization configurations, etc. The present application does not limit the implementation method of the process at 424.

430, training the initial neural network model with the quantization awareness to obtain the target neural network model based on the determined quantization configuration and training data set.

Based on the method described above, after automatically and reliably determining the different quantization configurations of the target neural network layer and other initial neural network layers in the initial neural network model, QAT training can be performed using different observers. After several rounds of QAT training (such as two or three rounds of smaller trainings), a maximum quantization range can be obtained, and then all neural network layers can be quantized by the above LSQ or LSQ+ quantization. That is, through LSQ or LSQ+ quantization, the automatically determined larger quantization range is adjusted to a smaller and more appropriate quantization range. In this way, while minimizing the deviation of the characteristic parameters of at least one target characteristic during the training process, the model quantization accuracy is improved as much as possible, thereby reducing the impact on the global performance of the model (such as accuracy and operating efficiency) until the training converges or the number of trainings reaches a training number threshold and other training termination conditions are met, thereby ensuring that the obtained target neural network model can meet the performance requirements such as business processing accuracy and operating speed.

Consistent with the present disclosure, the initial neural network model after initial quantization training can be updated with quantization configuration. By automatically measuring and quantifying different initial neural network layers, the characteristic parameter deviation of at least one target characteristic of each reference neural network model after processing the training data set can be obtained. At least one target neural network layer in the initial neural network model that is highly sensitive to the characteristic parameter deviation of at least one target characteristic feature can be quickly determined, and its quantization configuration can be different from the quantization configurations of other initial neural network layers in the initial neural network model. Based on different quantization configurations and training data sets, the initial neural network model can be trained with the quantization perception to ensure that the quantization accuracy of the target neural network model is sufficient and not too high, which not only meets the business processing accuracy requirements, but also improves the model operation efficiency and reduces the occupation of storage resources.

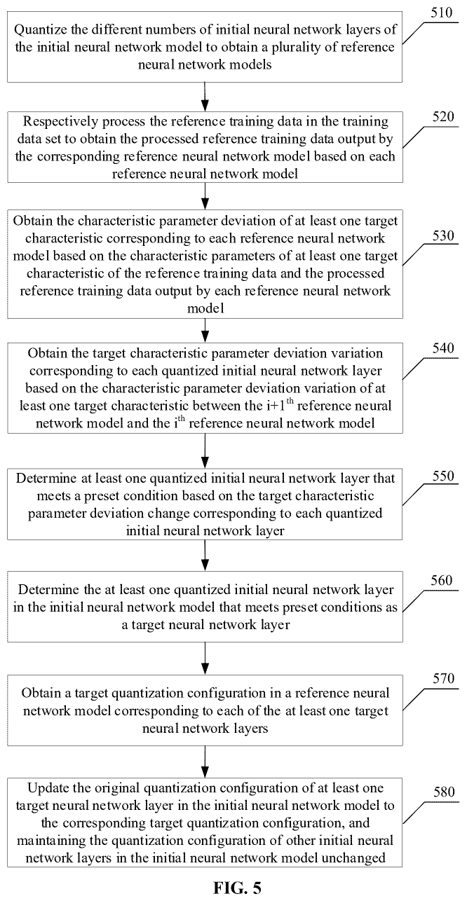

FIG. 5 is a flowchart of the model quantization implementation method according to some embodiments of the present disclosure. This embodiment can further describe the model quantization implementation method described above. For example, in the process at 420 described above, the quantization configuration update operation can be performed to determine an optional detailed implementation method of the quantization configuration of each initial neural network layer. For other processing steps of the model quantization implementation method, reference can be made to the description of the corresponding part of the above embodiment, which will not be repeated here. Based on this, as shown in FIG. 5, the quantization configuration update operation described above may include but is not limited to the following processes.

510, quantizing the different numbers of initial neural network layers of the initial neural network model to obtain a plurality of reference neural network models.

For the method of obtaining the initial neural network model, reference can be made to the description of the corresponding part of the above embodiment, which will not be described in detail here. To determine the target neural network layer in the initial neural network model, the quantization range of the initial neural network model may be dynamically adjusted. That is, different numbers of initial neural network layers can be quantized. For example, the high-precision floating-point parameters can be converted into low-precision fixed-point parameters, and the neural network model after quantization processing of any number of initial neural network layers can be determined as a reference neural network model to analyze the impact of different quantization ranges on the model quantization accuracy.

Based on this quantization processing method, the N reference neural network models obtained in the embodiments of the present application may have different quantization ranges. That is, the number of neural network layers that are quantized can be different, and the quantization accuracy of the corresponding reference neural network model can also be different, and the performance of processing business data can also be different. The present disclosure does not limit the number of neural network layers that are quantized in each reference neural network model, which can be set based on historical quantization data or experience, or can be determined by the total number of initial neural network layers included in the initial neural network model. For N reference neural network models, the i^{th} reference neural network model can be obtained by quantizing the i^{th} initial neural network layer. For example, four initial neural network layers in the initial neural network model are quantized, and only one network layer is quantized each time to obtain the 4^{th} reference neural network model.

In some embodiments, in the process of implementing the process at 510, the initial neural network layers that are gradually added in the initial neural network model can be quantized to obtain the corresponding N reference neural network models. At this time, the i^{th} reference neural network model is obtained by quantizing the initial neural network layers from layer 1 to layer i. For example, starting from the first layer of the initial neural network model, the corresponding reference neural network model is obtained after each quantization process. Based on this, the added initial neural network layer is quantized such that the reference neural network model after this quantization will sequentially add a layer of quantized neural network layer such that the number of quantized neural network layers in different reference neural network models is different. Both N and i are integers and i≤N. N can be determined based on the total number of initial neural network layers included in the initial neural network model.

For example, the first reference neural network model is obtained by quantizing the first initial neural network layer of the initial neural network model, where only the first neural network layer is quantized. The second reference neural network model is obtained by quantizing the initial neural network layers of the first and second layers of the initial neural network model, where only the first and second neural network layers are quantized. The third reference neural network model is obtained by quantizing the initial neural network layers of the first, second and third layers of the initial neural network model, where only the first, second and third neural network layers are quantized. In this way, the consecutive i neural network layers from the 1^{st} layer to the i^{th} layer in the i^{th} reference neural network model are quantized, and all neural network layers in the Nth reference neural network model are quantized.

It should be understood that in the layer-by-layer quantization processing process provided in the embodiments of the present disclosure, in addition to the incremental layer-by-layer quantization processing method starting from the first initial neural network layer, a decreasing layer-by-layer quantization processing method starting from the last initial neural network layer can also be used. Based on the progressive quantization training method provided in the embodiments of the present application, by measuring the deviation of the characteristic parameters of at least one target characteristic after each reference neural network model processes the training data set, the impact of adding/reducing a quantized initial neural network layer on the performance of the entire model can be more accurately obtained. In this way, the sensitive layer analysis of the initial neural network model can be automatically and reliably realized, and at least one initial neural network layer with a larger quantization range having a greater impact on the quantization accuracy can be determined as the target neural network layer.

520, respectively processing the reference training data in the training data set to obtain the processed reference training data output by the corresponding reference neural network model based on each reference neural network model.

In the process of analyzing the variation of characteristic parameter deviation of different quantized initial neural network layers, in order to improve the analysis accuracy, the quantization accuracy loss caused by different quantization ranges may be accurately determined, thereby improving the accuracy and reliability of the determined target neural network layer. The training data sets may be configured with training data and reference training data. The reference training data may have the same data type as the training data, and the reference training data may be data with the same one or more characteristics as the training data, which reduces the adverse effects of interfering characteristic data on the analysis results during the above analysis process and improves the analysis efficiency.

For example, if the training data set is an image data set, the training data may be a training image composed of any image collected or obtained from a third platform or a third device, and the reference training data may be an image with a single color, i.e., a pure color image. If the training data set is a speech data set, the training data may be a training speech composed of any speech signal collected or obtained from a third party, and the reference training data may be speech data with a single speech signal content, such as a single word speech signal, etc. The present disclosure does not limit the content of various types of reference training data and their acquisition methods.

Refer to the relevant description of the process at 422. After obtaining each reference neural network model based on the method described above, the reference training data in the training data set can be processed based on the reference neural network model to obtain the corresponding processed reference training data. For example, a reference image can be input into the reference neural network model for denoising to obtain a denoised reference image; or a reference speech can be input into the reference neural network model for enhancement to obtain an enhanced reference speech, etc. The method for processing the reference training data by the reference neural network model can be determined based on the model type, and will not be described in detail in the embodiments of the present application.

530, obtaining the characteristic parameter deviation of at least one target characteristic corresponding to each reference neural network model based on the characteristic parameters of at least one target characteristic of the reference training data and the processed reference training data output by each reference neural network model.

Continue with the above analysis. After obtaining the processed reference training data output by each reference neural network model, the characteristic parameters of at least one target characteristic can be extracted from the input reference training data and the corresponding output processed reference training data. Based on this, the characteristic parameter deviation corresponding to the quantized neural network layer of the reference neural network model that is increased or decreased relative to the last obtained reference neural network model can be obtained. Since each quantized neural network layer has a one-to-one corresponding initial neural network layer, the characteristic parameter deviation also corresponds to the initial neural network layer. That is, the characteristic parameter deviation of at least one target characteristic corresponding to each quantized initial neural network layer can be obtained in the process at 530. In some embodiments, if there are multiple reference training data, the characteristic parameter deviation of the same target characteristic described above may be an average value of the characteristic parameter deviations of the target characteristic for multiple reference training data.

Assume that the present disclosure uses L to represent the characteristic parameter deviation. In this way, after the initial neural network model processes the reference training data, the characteristic parameter deviation of at least one target characteristic between the input reference training data and the output processed reference training data can be recorded as L0. In this way, the i^{th} reference neural network model can be obtained by quantizing the initial neural network layers 1 to i, and the characteristic parameter deviation of at least one target characteristic after processing the reference training data can recorded as Li. In this way, N+1 characteristic parameter deviations such as L0, L1, L2, . . . , Li, . . . , LN can be obtained.

Take the reference training data as a pure color image and at least one target characteristic as a color characteristic as an example. The asymptotic change of the color saturation of each reference neural network model can be obtained. Based on the method described above, the initial neural network model can process each pure color image to obtain the average value of the color deviation of all processed pure color images relative to the input pure color image, which is recorded as the color deviation amount L0. The color deviation test process on the pure color image set may include but is not limited to: obtaining the color value (i.e., color pixel value, a value between 0-255) histogram of each pure color image, obtaining the color histogram of the processed pure color image, and selecting the maximum color value from them for difference calculation to obtain the color deviation. If the difference between the maximum color values of the input pure color image and the processed pure color image is greater than a threshold (e.g., 5, the present disclosure does not limit the threshold), the color deviation can be considered as too large and the model performance is low.

Therefore, the color difference test process of each reference neural network model on the reference image may include obtaining a first color histogram of each reference image input to the reference neural network model, and a second color histogram of the corresponding processed reference image output by the reference neural network model; determining the target color corresponding to the maximum pixel value in the second color histogram and the first color histogram; obtaining the first pixel value of the target color in the input reference image of the reference neural network model, and the second pixel value of the target color in the corresponding output processed reference image; and determining the pixel difference between the second pixel value and the first pixel value as a color deviation of the corresponding reference image.

In this way, the initial neural network model can perform color deviation test on the pure color image set and obtain the corresponding color deviation L0, which is recorded as L0=color_deviation (f₁, f₂, f₃, . . . f_{N}). The first initial neural network layer of the initial neural network model can be quantized (such as converting the floating-point parameters of the layer into fixed-point parameters, etc.) to obtain the first reference neural network model. The other neural network layers can still be the initial neural network layers (their model parameters are still high-precision floating-point parameters). Based on the method described above, the color deviation test can be performed on the pure color image set to obtain the corresponding color deviation L1, which is recorded as L1=color_deviation (d₁, d₂, f₃, . . . f_{N}). Continuing to quantize the second initial neural network layer based on the reference neural network model, or based on the initial neural network model, quantizing the first and second initial neural network layers to obtain a second reference neural network model and its color deviation L2 on the pure color image set, which is recorded as L2=color_deviation(d₁, d₂, f₃, . . . f_{N}). By performing quantization training in this manner, the color deviation Li corresponding to the i^{th} reference neural network model can be obtained and recorded as Li=color_deviation (d₁, d₂, . . . dᵢ, fᵢ+1, f_{N}), until all initial neural network layers are quantized, and the color deviation LN corresponding to the N^{th} reference neural network model is obtained and recorded as LN=color_deviation (d₁, d₂, d₃, . . . d_{N}). For the quantization state of the neural network layer corresponding to each element in color deviation( ), dᵢ indicates that the initial neural network layer of the i^{th} layer is quantized and is a low-precision fixed-point parameter, and fᵢ indicates that the initial neural network layer of the i^{th} layer is not quantized and is still a high-precision floating-point parameter.

The testing process of the initial neural network model and the N+1 models composed of N reference neural network models on the reference training data in the training data set of other data types is similar to the color deviation testing process described above, which will not be described in detail here. Of course, in the process of color deviation test, the average color value deviation between the input pure color image (or color image) and the pure color image processed by the model can be obtained by, but not limited to, the color deviation acquisition method based on the color histogram described above.

540, obtaining the target characteristic parameter deviation variation corresponding to each quantized initial neural network layer based on the characteristic parameter deviation variation of at least one target characteristic between the i+1^{th} reference neural network model and the i^{th} reference neural network model.

550, determining at least one quantized initial neural network layer that meets a preset condition based on the target characteristic parameter deviation change corresponding to each quantized initial neural network layer.

560, determining the at least one quantized initial neural network layer in the initial neural network model that meets preset conditions as a target neural network layer.

The N reference neural network models obtained by this progressive quantization training method (i.e., quantizing each layer from the first layer in the order of the initial neural network layers in the initial neural network model) correspond to an increasing number of quantized neural network layers, and the i+1^{th} reference neural network model has one more quantized layer than the i^{th} reference neural network model. That is, the quantization range of the initial neural network model is gradually adjusted. In this way, the quantization configurations of two adjacent reference neural network models can be associated to more accurately determine the target neural network layer whose characteristic parameter deviation meets the preset condition.

Based on this, in some embodiments, the progressive quantization training can start from the first layer and gradually increases layer by layer. Each time an initial neural network is quantized, the corresponding N reference neural network models can be obtained. After respective testing on each reference training data, at least one characteristic parameter deviation corresponding to an initial neural network layer with increased quantization can be obtained, and the target characteristic parameter deviation increment (i.e., the target characteristic parameter deviation change) can be obtained, such as ∇Li=Li−L(i−1), i=1, 2, 3 . . . , N. Based on this, at least one target neural network layer that has a greater impact on the model quantization accuracy can be determined.

In some embodiments, based on the order of the target characteristic parameter deviation changes corresponding to the quantized initial neural network layers, at least one initial neural network layer corresponding to the larger target characteristic parameter deviation change can be selected as the target neural network layer. For example, if K larger target characteristic parameter deviation changes are selected, the corresponding initial neural network layer to be quantized can be determined as the target neural network layer, and K can be an integer such as 1, 2, or 3. The value of K can be determined based on the actual quantization accuracy and quantization range requirements. The preset condition in the process at S550 may include screening the target characteristic parameter deviation changes greater than the characteristic parameter deviation change threshold, or screening the target characteristic parameter deviation changes ranked (sorted from large to small) with a specified number K of larger target characteristic parameter deviation changes, etc., but are not limited to the implementation method described in the embodiments of the present application.

In some embodiments, an initial neural network layer corresponding to the maximum target characteristic parameter deviation change may be directly selected as the target neural network layer, that is, the initial neural network layer whose model before and after quantization processing has the greatest impact on the business processing performance, that is, the initial neural network layer with the highest sensitivity to the target characteristic parameter deviation. By updating the quantization configuration of the target neural network layer, that is, correcting the QAT configuration of the target neural network layer in the initial neural network model, such that the target neural network layer executes the updated quantization configuration, after candidate quantization training, the operating efficiency and accuracy of the quantized neural network model can be quickly and reliably improved, and a target neural network model with a suitable quantization range and sufficient quantization accuracy can be obtained.

570, obtaining a target quantization configuration in a reference neural network model corresponding to each of the at least one target neural network layers.

580, updating the original quantization configuration of at least one target neural network layer in the initial neural network model to the corresponding target quantization configuration, and maintaining the quantization configuration of other initial neural network layers in the initial neural network model unchanged.

Based on the method described above, the target quantization configuration of the target neural network layer in the corresponding reference neural network model can be used to determine at least one target neural network layer in the initial neural network model that meets the preset condition. Then, the quantization configuration of the target neural network layer in the initial neural network model can be corrected. For example, the quantization configuration (i.e., the observer) of a target neural network layer with the highest sensitivity can be updated to max min observer, and the quantization configurations of other initial neural network layers can remain unchanged, and still be the original moving max min observer. It should be noted that the observers are not limited to these two types of observers and can be determined based on the quantization method used in the process of acquiring the initial neural network model.

Continue with the example where the training dataset is an image dataset. In some embodiments, color saturation perception quantization training can be adopted such that the quantization training focuses on minimizing the color deviation of the input and output images. In addition, through progressive quantization training, the color deviation can be reduced while maintaining the original image quality as much as possible such that the color of the image before and after super-resolution remains consistent (that is, the color deviation is less than the threshold), the output image quality is improved, and the image color is refined.

Consistent with the present disclosure, a quantization configuration update operation can be added to the initial neural network model, and a reference neural network model can be obtained after quantization processing in different quantization ranges through progressive quantization training. The characteristic parameter deviation test can be performed on at least one target characteristic on the reference training data. Considering minimizing the deviation of the target characteristic parameters and also improving the quantization accuracy of the model as quickly as possible, only the quantization configuration of the selected target neural network layer is updated to make it different from the quantization configuration of other initial neural network layers. By performing quantization perception training on the initial neural network model corresponding to different observers, compared with the method of using the same observer to perform quantization training on each initial neural network layer, in this embodiment the maximum quantization range is adjusted to a smaller and more suitable quantization range, and the highest model quantization accuracy is obtained, which reduces the target neural network model's characteristic loss for the processed data. Compared with the method of manually selecting the target neural network layer, in the present disclosure the quantization configuration is automatically updated and the quantization range is dynamically adjusted, which reduces the labor cost, improves the accuracy of the quantization range, and obtains smaller memory footprint, power consumption and latency such that the final target neural network model can reliably meet the business processing needs.

In some embodiments, in the process of quantizing different initial neural network layers, each initial neural network layer of the initial neural network model can also be quantized separately to obtain multiple reference neural network models. For example, each of the N initial neural network layers can be quantized to obtain N reference neural network models containing the corresponding quantized neural network layers. At this time, each reference neural network model only contains one quantized neural network layer, and the other layers are still the corresponding initial neural network layers. The quantization conversion implementation process of each initial neural network layer will not be described in detail in this application.

Subsequently, the characteristic parameter deviation test of at least one target characteristic can still be performed on the reference training data based on each reference neural network model to obtain the characteristic parameter deviation of at least one target characteristic corresponding to each reference neural network model, thereby obtaining the target characteristic parameter deviation corresponding to each quantized initial neural network layer. Refer to the description of the corresponding part of the above embodiment, the target characteristic parameter deviation corresponding to each initial neural network layer can be recorded as Li, i=1, 2, 3 . . . , N, and the calculation process will not be repeated here.

Since the number of neural network layers to be quantized in each reference neural network model in this embodiment is the same and only the neural network layers to be quantized are different, in this way, the characteristic parameter deviation change corresponding to each quantized initial neural network layer can be obtained based on the characteristic parameter deviation change of at least one target characteristic between each reference neural network model and the initial neural network model, that is, based on the target characteristic parameter deviation change between each reference neural network model and the initial neural network model, which is recorded as ∇Li=Li−L0, which can be used to evaluate whether the corresponding quantization range of each initial neural network layer is appropriate, that is, the corresponding quantization range has a greater impact on the model quantization accuracy, thereby determining at least one sensitive layer with a greater impact, that is, the target neural network layer. For the implementation of the method of determining at least one target neural network layer in the initial neural network model based on characteristic parameter deviation, the method of determining the different quantization configurations of the target neural network and other initial neural network layers to complete the quantization perception training of the initial neural network model through different observers to obtain the target neural network model, reference can be made to the description of the corresponding part of the foregoing embodiments, which will not be repeated here.

In the quantization configuration update operation process in the model quantization implementation method described in the foregoing embodiments, in some embodiments, when the reference training data is processed based on each reference neural network model to obtain the characteristic parameter deviations of multiple target characteristics, the characteristic parameter deviations of the multiple target characteristics corresponding to each of the quantized initial neural network layers can be integrated to obtain the target characteristic parameter deviation corresponding to the corresponding initial neural network layer. For example, the target characteristic parameter deviations of the multiple target characteristics corresponding to any quantized initial neural network layers can be averaged or average weighted (the present disclosure does not limit the weight values of various target characteristics, which can be determined based on the circumstances) to obtain the target characteristic parameter deviation corresponding to the quantized initial neural network layer. That is, the test results of any of the reference neural network models described above by performing target characteristic deviation tests on the reference training data.

Continuing with the example where the neural network model's characteristic parameter deviation test is performed on a pure color image set, if there is a need to use the model to improve the color (any color in red, green, blue) deviation and brightness deviation of the image, the pure color image can be processed based on the initial neural network model and each model in each reference neural network model to obtain the color value and brightness of the processed pure color image, and then compared them with the color value and brightness of the original pure color image to obtain the color deviation and brightness deviation of the pure color image before and after the model is processed (corresponding to the characteristic parameter deviation of the multiple target characteristics described above). The average or weighted average of the color deviation and the brightness deviation can be determined as the color difference of the model (corresponding to the target characteristic parameter deviation described above), thereby evaluating the quantization accuracy under the quantization range of the corresponding reference neural network model.

Subsequently, based on the method described above, difference calculation can be performed on the target characteristic parameter deviation of the i+1^{th} reference neural network model and the i^{th} reference neural network model to obtain the target characteristic parameter deviation change corresponding to the (i+1)^{th} initial neural network layer that is quantized. In this way, at least one target neural network layer in the initial neural network model, that is, an initial neural network layer with high sensitivity to the target characteristic parameter deviation, can be determined by sorting the target characteristic parameter deviation changes corresponding to each layer. For the determination method, reference can be made to the description of the corresponding part of the foregoing embodiments, which will not be repeated here.

FIG. 6 is a flowchart of the model quantization implementation method according to some embodiments of the present disclosure. The method will be described in detail below.

610, obtaining an initial neural network model, the initial neural network model including a plurality of initial neural network layers, the initial neural network model being obtained by performing quantization perception training based on a training data set.

620, performing a quantization configuration update operation to determine a different quantization configuration of at least one target neural network layer in the initial neural network from other initial neural network layers.

630, training the initial neural network model for quantization perception to obtain the quantized pending neural network model based on the determined quantization configuration and the training data set.

640, determining whether the characteristic parameter deviation of at least one target characteristic after the pending neural network model processes the test data in the training data set meets the training termination condition. If not, return to the process at 620 to continue to perform the quantization configuration update operation on the pending neural network model; otherwise, proceed to the process at 650.

650, determining the pending neural network model as the target neural network model.

For the implementations of the processes at 610 and 620, reference can be made to the description of the corresponding processes in the model quantization implementation methods described in the foregoing embodiments, which will not be repeated here. Based on the quantization configuration update operation implementation method described above, a quantization configuration update operation can be performed to determine the different quantization configurations of the target neural network layer and other initial neural network layers in the initial neural network model. The training data in the training data set can be used to perform two rounds (or other small number of trainings) of QAT training on the initial neural network model through the corresponding different observers. Then LSQ or LSQ+ quantization can continue to be performed on all neural network layers to ensure high quantization accuracy during the quantization training process while adjusting a smaller and more appropriate quantization range until the training converges, and the final fixed-point model can be determined as the undetermined neural network model to be tested. The implementation methods of QAT quantization and LSQ quantization can be determined based on their respective model quantization principles, and the present disclosure will not describe them in detail.

Subsequently, the test data in the training data set can be used to test the characteristic parameter deviation of at least one target characteristic of the neural network model to be tested. If the test passes, it may indicate that the training termination condition is met, the pending neural network model has reasonably weighed the quantization accuracy and quantization range, and the performance of the entire model meets the business processing requirements. At this time, the pending neural network model can be recorded as the target neural network model. If the test fails, it may indicate that the selected target neural network layer is not suitable, and secondary quantization configuration update operations can continue to be performed on the pending neural network model. That is, the pending neural network model can be used as the new initial neural network model described in the foregoing embodiments, and the quantization configuration update operation can be performed again. Based on the determined different quantization configurations and training data sets, a new candidate neural network model can be obtained through the quantization awareness training, and then the new candidate neural network model is subjected to a parameter deviation test. If the test passes, the new pending neural network model can be determined as the target neural network model. If the test fails, the quantization configuration update operation can be continued for the new pending neural network model. The subsequent implementation process is similar to the process described above and will not be described in detail in the present disclosure.

In some embodiments, in the process of testing the characteristic parameter deviation on the pending neural network model, the test data used can still be data of the same type as the reference training data described above, such as a reference image of pure color, a reference speech of single speech content, a reference text data of a single element, etc. The testing process is similar to the characteristic parameter deviation testing process of the reference neural network model on the reference training data described above, which will not be repeated here.

For example, if the test data is a pure color image and is input into the pending neural network model for processing, after the processed pure color image is obtained, the color deviation can be performed through the target color corresponding to the maximum pixel value in each color histogram to determine whether the training termination condition is met. If the color deviation is less than a threshold (e.g., 5), the pending neural network model can process the pure color image, and the processed pure color image will have no color difference even at high saturation. In this way, the determined target neural network model can improve the quantization quality compared to the global quantization of each layer of the initial neural network model. That is, when the number of quantization bits is limited, the quantization range is reasonably improved while ensuring image quality, reducing the impact of model quantization on the performance of the entire model, reducing the target neural network model's consumption of electronic device operating resources, and increasing the model's operating speed, thereby improving business processing efficiency and performance.

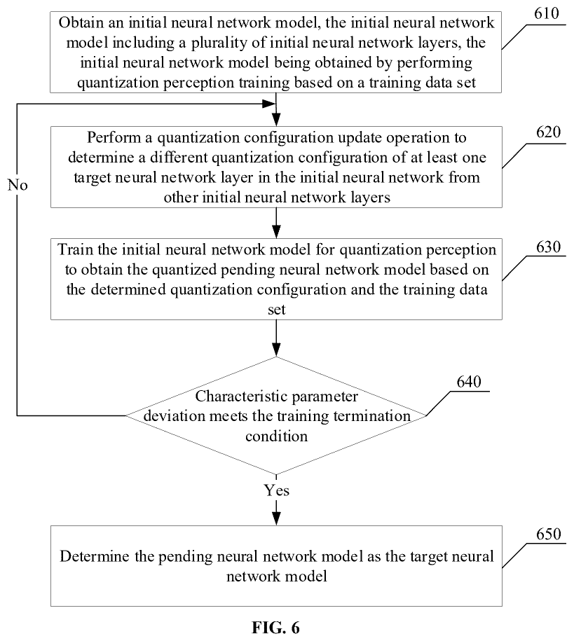

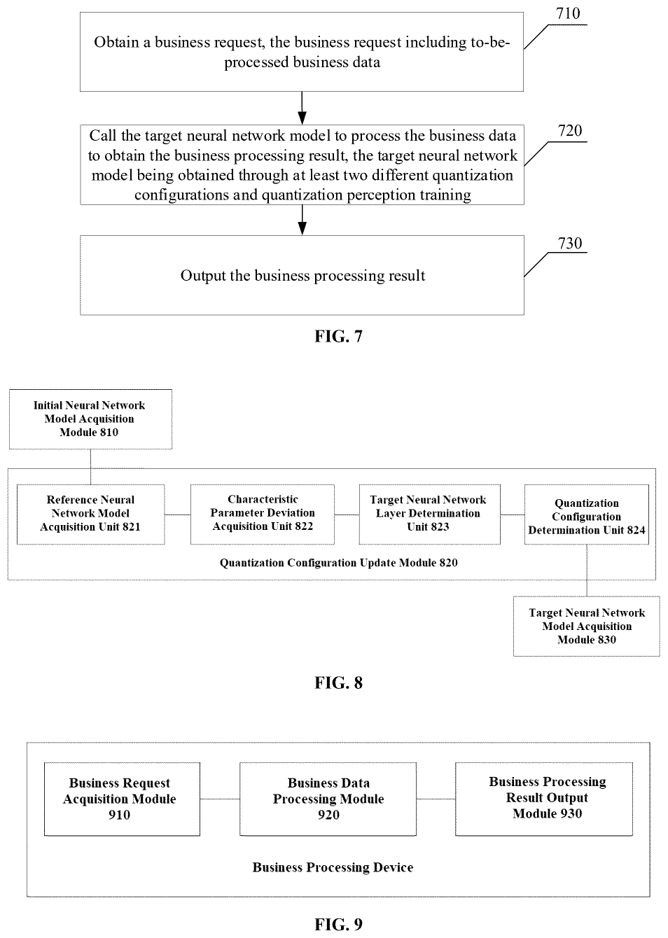

FIG. 7 is a flowchart of the business processing method according to some embodiments of the present disclosure. The method can be applied to a business device, which can be a terminal device or a server, and can refer to but is not limited to the application scenario shown in FIG. 3. The method will be described in detail below.

710, obtaining a business request, the business request including to-be-processed business data.

In some embodiments, the business request may be generated by a business person using one or more input components of a business device (e.g., a touch screen, a physical keyboard, a function key (e.g., a volume control key, a switch key, etc.), a trackball, a mouse, a joystick, etc.) to perform an input operation. The business request may also be that, after receiving or detecting the to-be-processed business data, a corresponding business request is automatically generated to obtain the corresponding business processing result based on the business processing method provided in the embodiments of the present disclosure. The present disclosure does not restrict the method of obtaining the business request and its content, which can be determined based on the circumstances.

In some embodiments, the business data may include but is not limited to one or more of image data, audio data, and text data, and may be determined based on actual business scenarios.

720, calling the target neural network model to process the business data to obtain the business processing result, the target neural network model being obtained through at least two different quantization configurations and quantization perception training.

730, outputting the business processing result.

As shown in the application scenario of FIG. 3, in the process of responding to the business request, the business device can call the target neural network model adapted to the to-be-processed business data from the target neural network models for different types of business data stored in the electronic device through wireless network communication or wired network communication. Or the business device may call the corresponding target neural network model stored in the business device to process the business data and output the corresponding business processing data.

In some embodiments, the business device may also send the business request to the electronic device, which will parse the to-be-processed business data, call the corresponding quantized target neural network model to process the business data, and feedback the business processing results to the business device for output. The present disclosure does not limit the system architecture of the business processing method.

It should be noted that the output of business result may include but is not limited to output using output components such as a display screen or an audio player, and the business output may also be output to other devices or other processors through a communication connection port to continue to perform subsequent tasks on the processed business data such as segmentation of the denoised image. The present disclosure does not limit the implementation of the process at 730. In addition, the business device and the electronic device may also be the same device, or different processing devices integrated in the same device such that it can be applied to the model quantization implementation method and business processing method provided in the embodiments of the present application. The implementation process will not be described in detail in the present disclosure.

For example, if the business request indicates that the to-be-processed image needs to be denoised, the target neural network model can be an image denoising model quantized based on the model quantization implementation method provided in the embodiments of the present application, and the to-be-processed image can be input into the target neural network model for denoising, and the denoised image can be output. As described in the foregoing embodiments, the target neural network model can be obtained by at least two different quantization configurations and quantization perception training, which reasonably balances the quantization accuracy and quantization range, reduces the consumption of processing resources, makes it suitable for more types of business equipment, improves the efficiency and reliability of image denoising, and reduces the image quality loss after denoising, so as to meet the subsequent processing requirements of the denoised image.

Similarly, in business scenarios such as image segmentation, object recognition, speech enhancement, or text classification, the corresponding quantized target neural network model can be called to process the corresponding input business data, such as image segmentation model, target recognition model, audio enhancement model or text classification model, and obtain the corresponding business processing result quickly, reliably and accurately. The specific implementation process will not be described in detail here.

In some embodiments, the two different quantization configurations may include at least a first quantization configuration and a second quantization configuration. The first quantization configuration and the second quantization configuration may have different quantization range update methods. For example, the first quantization configuration may be the max min observer, and the second quantization configuration may be the moving max min observer, but the present disclosure is not limited thereto.

In some embodiments, the neural network layer in the target neural network model corresponding to the first quantization configuration may have a first influence on the characteristic parameter deviation of at least one target characteristic of the business processing result, the neural network layer in the target neural network model corresponding to the second quantization configuration may have a second influence on the characteristic parameter deviation of at least one target characteristic of the business processing result, and the first influence may be greater than the second influence. In view of the above description of the model quantization implementation method, model quantization can convert high-precision floating-point parameters into low-precision fixed-point parameters, which may sacrifice a certain degree of model output accuracy. However, the technical solutions provided in the present disclosure can reasonably weigh the quantization accuracy and quantization range. Even if the accuracy of the model output is affected, the impact is minimal, and the business processing results of the business data can still meet the business performance requirements. In addition, the quantized target neural network model requires lower memory consumption, power consumption, and latency, thereby improving business processing efficiency.

The above describes the model quantization implementation method provided in the embodiments of the present disclosure. The following describes a device for executing the above model quantization implementation method.

FIG. 8 is a schematic diagram of the structure of a model quantization implementation device according to some embodiments of the present disclosure. As shown in FIG. 8, the model quantization implementation device includes an initial neural network model acquisition module 810, a quantization configuration update module 820, and a target neural network model acquisition module 830.

In some embodiments, the initial neural network model acquisition module 810 may be configured to obtain an initial neural network model. The initial neural network model may include a plurality of initial neural network layers and may be obtained by performing quantization perception training based on a training data set.

In some embodiments, the quantization configuration update module 820 may be configured to perform a quantization configuration update operation to determine the quantization configuration of each of the initial neural network layers.

In some embodiments, the quantization configuration update module 820 may include a reference neural network model acquisition unit 821, a characteristic parameter deviation acquisition unit 822, a target neural network layer determination unit 823, and a quantization configuration determination unit 824.

In some embodiments, the reference neural network model acquisition unit 821 may be configured to quantize different initial neural network layers to obtain the reference neural network model corresponding to the quantized initial neural network layer.

In some embodiments, the characteristic parameter deviation acquisition unit 822 may be configured to obtain the characteristic parameter deviation of at least one target characteristic after each reference neural network model processes the training data set.

In some embodiments, the target neural network layer determination unit 823 may be configured to determine at least one target neural network layer in the initial neural network model based on the characteristic parameter deviation.

In some embodiments, the quantization configuration determination unit 824 may be configured to determine different quantization configurations corresponding to the at least one target neural network layer and other initial neural network layers in the initial neural network model.

In some embodiments, the target neural network model acquisition module 830 may be configured to perform quantization awareness training on the initial neural network model based on the determined quantization configuration and the training data set to obtain a target neural network model.

In some embodiments, the reference neural network model acquisition unit 821 may include a first quantization processing unit. The first quantization processing unit may be configured to quantize different numbers of the initial neural network layers of the initial neural network model to obtain multiple reference neural network models. Or, the reference neural network model acquisition unit 821 may include a second quantization processing unit. The second quantization processing unit may be configured to quantize each of the initial neural network layers of the initial neural network model to obtain multiple reference neural network models.

Based on this, the characteristic parameter deviation acquisition unit 822 may include a first processing unit and a first acquisition unit. The first processing unit may be configured to process the reference training data in the training data set based on each of the reference neural network models to obtain the processed reference training data output by the corresponding reference neural network model. The first acquisition unit may be configured to obtain the characteristic parameter deviation of at least one target characteristic corresponding to each quantized initial neural network layer based on the characteristic parameters of at least one target characteristic of each of the reference training data and the processed reference training data output by each of the reference neural network models.

In some embodiments, the target neural network layer determination unit 823 may include a second acquisition unit, a third acquisition unit, a first determination unit, and a second determination unit. The second acquisition unit may be configured to, if the number of quantized neural network layers in each of the reference neural network models is different, based on the characteristic parameter deviation change of at least one target characteristic between the i+1^{th} reference neural network model and the i^{th} reference neural network model, obtain the target characteristic parameter deviation variation corresponding to each quantized initial neural network layer. The i^{th} reference neural network model may be obtained by quantizing i consecutive layers or the 1st to i^{th} initial neural network layers, where i is an integer. The third acquisition unit may be configured to, if the number of quantized neural network layers in each of the reference neural network models is the same, but the quantized neural network layers are different, based on the characteristic parameter deviation change of at least one target characteristic between each reference neural network model and the initial neural network model, obtain the target characteristic parameter deviation variation corresponding to each quantized initial neural network layer. The first determination unit may be configured to determine at least one of the quantized initial neural network layers that meets a preset condition based on the target characteristic parameter deviation change corresponding to each quantized initial neural network layer. The second determination unit may be configured to determine at least one of the quantized initial neural network layers in the initial neural network model that meets the preset condition as the target neural network layer.

In some embodiments, the target neural network layer determination unit 823 may also include an integrated processing unit and a third determination unit. The integrated processing unit may be configured to integrate the characteristic parameter deviations of the multiple target characteristics corresponding to the initial neural network layers that have been quantized, and obtain the target characteristic parameter deviations corresponding to the initial neural network layers that have been quantized. The third determination unit may be configured to determine at least one target neural network layer in the initial neural network model based on the target characteristic parameter deviation corresponding to each quantized initial neural network layer.

In some embodiments, the quantization configuration determination unit 824 may include a target quantization configuration acquisition unit and an update unit. The target quantization configuration acquisition unit may be configured to obtain a target quantization configuration in a reference neural network model corresponding to each of the at least one target neural network layers. The update unit may be configured to update the original quantization configuration of at least one target neural network layer in the initial neural network model to the corresponding target quantization configuration, and maintain the quantization configurations of other initial neural network layers in the initial neural network model unchanged.

In some embodiments, target neural network model acquisition module 830 may be configured to a training unit, a fourth determination unit, and a fifth determination unit. The training unit may be configured to perform quantization awareness training on the initial neural network model based on the determined quantization configuration and the training data set to obtain a quantized pending neural network model. The fourth determination unit may be configured to, if it is determined that the characteristic parameter deviation of at least one target characteristic after the pending neural network model processes the test data in the training data set does not meet the training termination condition, trigger the quantization configuration update module 820 to continue to perform the quantization configuration update operation on the pending neural network model. The fifth determination unit may be configured to, if it is determined that the characteristic parameter deviation of at least one target characteristic after the pending neural network model processes the test data in the training data set satisfies the training termination condition, determine the pending neural network model as the target neural network model.

In combination with a business processing method provided by an embodiment of the present disclosure, a device for executing the above business processing method will be introduced below.

FIG. 9 is a schematic diagram of the structure of a business processing device according to some embodiments of the present disclosure. As shown in FIG. 9, the business processing device includes a business request acquisition module 910, a business data processing module 920, and a business processing result output module 930. The business request acquisition module 910 may be configured to obtain a business request, the business request including to-be-processed business data. The business data processing module 920 may be configured to call the target neural network model to process the business data and obtain a business processing result, the target neural network model being obtained by at least two different quantization configurations and quantization perception training. The business processing result output module 930 may be configured to output the business processing result.

In some embodiments, the two different quantization configurations may at least include a first quantization configuration and a second quantization configuration. The first quantization configuration and the second quantization configuration may have different quantization range update methods. The first quantization configuration may correspond to a neural network layer in the target neural network model having a first influence on a characteristic parameter deviation of at least one target characteristic of the business processing result. The second quantization configuration may correspond to a neural network layer in the target neural network model having a second influence on a characteristic parameter deviation of at least one target characteristic of the business processing result. The first influence may be greater than the second influence.

The present disclosure also provides a computer program product, comprising a plurality of first computer-readable instructions. When the first computer-readable instruction is executed on the electronic device, the electronic device can implement any one of the model quantization implementation methods provided in the embodiments of the present disclosure.

The present disclosure also provides another computer program product, comprising a plurality of second computer-readable instructions. When the second computer-readable instruction is executed on the business device, the business device can implement any business processing methods provided in the embodiments of the present application.

The present disclosure also provides a computer-readable storage medium that carries one or more first computer programs. When one or more first computer programs are executed by an electronic device, the electronic device can implement any one of the model quantization implementation methods provided in the embodiments of the present disclosure.

The present disclosure also provides another computer-readable storage medium that carries one or more second computer programs. When one or more second computer programs are executed by the business device, the business device can implement any business processing method provided in the embodiment of the present disclosure.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected based on an actual requirement to achieve the objectives of the solutions of the embodiments. In addition, in the accompanying drawings of the apparatus embodiments provided in this disclosure, connection relationships between modules indicate that the modules have communication connections with each other, which may be implemented as one or more communication buses or signal cables.

Based on the description of the foregoing embodiments, a person skilled in the art may clearly understand that this disclosure may be implemented by software in addition to necessary universal hardware, or by dedicated hardware, including a dedicated integrated circuit, a dedicated CPU, a dedicated memory, a dedicated component, and the like. Generally, any function that can be performed by a computer program can be easily implemented by using corresponding hardware. Moreover, a specific hardware structure used to achieve the same function may be in various forms, for example, in a form of an analog circuit, a digital circuit, or a dedicated circuit. However, as for this disclosure, software program implementation is a better implementation in most cases. Based on such an understanding, technical solutions of this disclosure essentially, or a part contributing to a conventional technology may be implemented in a form of a computer software product. The computer software product is stored in a readable storage medium, for example, a floppy disk of a computer, a USB flash drive, a removable hard disk, a ROM, a RAM, a magnetic disk, or an optical disc, and includes several instructions for instructing a computer device (which may be a personal computer, a training device, a network device, or the like) to perform the methods described in embodiments of this disclosure.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedures or functions according to the embodiments of this disclosure are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a training device or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

What is claimed is:

1. A model quantization implementation method comprising:
obtaining an initial neural network model, the initial neural network model including a plurality of initial neural network layers, the initial neural network model being obtained by performing quantization perception training based on a training data set;
performing a quantization configuration update operation to determine the quantization configuration of each of the initial neural network layers, which includes:
quantizing different initial neural network layers to obtain reference neural network models corresponding to the quantized initial neural network layers;
obtaining a characteristic parameter deviation of at least one target characteristic after each reference neural network model processes the training data set;
determining at least one target neural network layer in the initial neural network model based on the characteristic parameter deviation; and
determining different quantization configurations corresponding to at least one target neural network layer and other initial neural network layers in the initial neural network model; and
performing quantization awareness training on the initial neural network model to obtain a target neural network model based on the determined quantization configuration and the training data set.

2. The method of claim 1, wherein quantizing different initial neural network layers to obtain reference neural network models corresponding to the quantized initial neural network layers includes:
quantizing different numbers of the initial neural network layers of the initial neural network model to obtain multiple reference neural network models; or,
quantizing each of the initial neural network layers of the initial neural network model to obtain multiple reference neural network models; and
obtaining the characteristic parameter deviation of at least one target characteristic after each reference neural network model processes the training data set includes:
respectively processing reference training data in the training data set to obtain the processed reference training data output by the reference neural network model based on each of the reference neural network models; and
obtaining the characteristic parameter deviation of at least one target characteristic corresponding to each quantized initial neural network layer based on the reference training data and the characteristic parameters of at least one target characteristic of each of the processed reference training data output by each of the reference neural network models.

3. The method of claim 1, wherein determining at least one target neural network layer in the initial neural network model based on the characteristic parameter deviation includes:
if the number of quantized neural network layers in each of the reference neural network models is different, based on a characteristic parameter deviation change of at least one target characteristic between an i+1^{th} reference neural network model and an i^{th} reference neural network model, obtaining the target characteristic parameter deviation variation corresponding to each quantized initial neural network layer, the i^{th} reference neural network model being obtained by quantizing i consecutive layers or the 1^{st} to i^{th} initial neural network layers, where i is an integer;
if the number of quantized neural network layers in each of the reference neural network models is the same, but the quantized neural network layers are different, based on the characteristic parameter deviation change of at least one target characteristic between each reference neural network model and the initial neural network model, obtaining the target characteristic parameter deviation change corresponding to each quantized initial neural network layer;
based on the target characteristic parameter deviation change corresponding to each of the quantized initial neural network layers, determining at least one of the quantized initial neural network layers that meets a preset condition; and
determining at least one of the quantized initial neural network layers in the initial neural network model that meets the preset condition as the target neural network layer.

4. The method of claim 1, wherein determining at least one target neural network layer in the initial neural network model based on the characteristic parameter deviation includes:
integrating the characteristic parameter deviations of the multiple target characteristics corresponding to the initial neural network layers that have been quantized to obtain the target characteristic parameter deviations corresponding to each of the quantized initial neural network layers; and
determining at least one target neural network layer in the initial neural network model based on the target feature parameter deviations corresponding to each quantized initial neural network layer.

5. The method of claim 1, wherein determining the different quantization configurations corresponding to at least one target neural network layer and other initial neural network layers in the initial neural network model includes:
obtaining a target quantization configuration in the reference neural network model corresponding to each of the at least one target neural network layers; and
updating an original quantization configuration of at least one target neural network layer in the initial neural network model to the corresponding target quantization configuration, and maintaining the quantization configurations of other initial neural network layers in the initial neural network model unchanged.

6. The method of claim 1, wherein performing the quantization awareness training on the initial neural network model to obtain the target neural network model based on the determined quantization configuration and the training data set includes:
based on the determined quantization configuration and the training data set, training the initial neural network model with quantization perception to obtain a quantized pending neural network model;
if it is determined that the characteristic parameter deviation of at least one target characteristic after the pending neural network model processes test data in the training data set does not meet a training termination condition, continuing to perform the quantization configuration update operation on the pending neural network model; or
if it is determined that the characteristic parameter deviation of at least one target characteristic after the pending neural network model processes the test data in the training data set meets the training termination condition, determining the pending neural network model as the target neural network model.

7. A business processing method comprising:
obtaining a business request, the business request including to-be-processed business data;
calling a target neural network model to process the business data to obtain a business processing result, the target neural network model being obtained by performing quantization perception training of at least two different quantization configurations; and
outputting the business processing result.

8. The method of claim 7, wherein:
the two different quantization configurations include at least a first quantization configuration and a second quantization configuration, the first quantization configuration and the second quantization configuration having different quantization range update modes, wherein:
the first quantization configuration corresponds to a neural network layer in the target neural network model having a first influence on a characteristic parameter deviation of at least one target characteristic of the business processing result;
the second quantization configuration corresponds to a neural network layer in the target neural network model having a second influence on the characteristic parameter deviation of at least one target characteristic of the business processing result; and
the first influence is greater than the second influence.

9. A business device comprising:
one or more second processors; and
one or more second memories coupled to the one or more second processors and storing a plurality of second computer instructions that, when being executed, cause the one or more second processors to perform the method of claim 1.

10. The business device of claim 9, wherein:
the two different quantization configurations include at least a first quantization configuration and a second quantization configuration, the first quantization configuration and the second quantization configuration having different quantization range update modes, wherein:
the first quantization configuration corresponds to a neural network layer in the target neural network model having a first influence on a characteristic parameter deviation of at least one target characteristic of the business processing result;
the second quantization configuration corresponds to a neural network layer in the target neural network model having a second influence on the characteristic parameter deviation of at least one target characteristic of the business processing result; and
the first influence is greater than the second influence.

11. An electronic device comprising:
one or more first processors; and
one or more first memories coupled to the one or more first processors and storing a plurality of first computer instructions that, when being executed, cause the one or more first processors to:
obtain an initial neural network model, the initial neural network model including a plurality of initial neural network layers, the initial neural network model being obtained by performing quantization perception training based on a training data set;
perform a quantization configuration update operation to determine the quantization configuration of each of the initial neural network layers, which includes:
quantize different initial neural network layers to obtain reference neural network models corresponding to the quantized initial neural network layers;
obtain a characteristic parameter deviation of at least one target characteristic after each reference neural network model processes the training data set;
determine at least one target neural network layer in the initial neural network model based on the characteristic parameter deviation of at least one target characteristic corresponding to each of the quantized initial neural network layers, the target neural network layer being the quantized initial neural network layer corresponding to the characteristic parameter deviation that meets a preset condition; and
determine different quantization configurations corresponding to at least one target neural network layer and other initial neural network layers in the initial neural network model; and
perform quantization awareness training on the initial neural network model to obtain a target neural network model based on the determined quantization configuration and the training data set.

12. The electronic device of claim 11, wherein the one or more first processors are further configured to:
quantize different numbers of the initial neural network layers of the initial neural network model to obtain multiple reference neural network models; or,
quantize each of the initial neural network layers of the initial neural network model to obtain multiple reference neural network models; and
obtain the characteristic parameter deviation of at least one target characteristic after each reference neural network model processes the training data set includes:
respectively process reference training data in the training data set to obtain the processed reference training data output by the reference neural network model based on each of the reference neural network models; and
obtain the characteristic parameter deviation of at least one target characteristic corresponding to each quantized initial neural network layer based on the reference training data and the characteristic parameters of at least one target characteristic of each of the processed reference training data output by each of the reference neural network models.

13. The electronic device of claim 11, wherein the one or more first processors are further configured to:
if the number of quantized neural network layers in each of the reference neural network models is different, based on a characteristic parameter deviation change of at least one target characteristic between an i+1^{th} reference neural network model and an i^{th} reference neural network model, obtain the target characteristic parameter deviation variation corresponding to each quantized initial neural network layer, the i^{th} reference neural network model being obtained by quantizing i consecutive layers or the 1^{st} to i^{th} initial neural network layers, where i is an integer;
if the number of quantized neural network layers in each of the reference neural network models is the same, but the quantized neural network layers are different, based on the characteristic parameter deviation change of at least one target characteristic between each reference neural network model and the initial neural network model, obtain the target characteristic parameter deviation change corresponding to each quantized initial neural network layer;
based on the target characteristic parameter deviation change corresponding to each of the quantized initial neural network layers, determine at least one of the quantized initial neural network layers that meets a preset condition; and
determine at least one of the quantized initial neural network layers in the initial neural network model that meets the preset condition as the target neural network layer.

14. The electronic device of claim 11, wherein the one or more first processors are further configured to:
integrate the characteristic parameter deviations of the multiple target characteristics corresponding to the initial neural network layers that have been quantized to obtain the target characteristic parameter deviations corresponding to each of the quantized initial neural network layers; and
determine at least one target neural network layer in the initial neural network model based on the target feature parameter deviations corresponding to each quantized initial neural network layer.

15. The electronic device of claim 11, wherein the one or more first processors are further configured to:
obtain a target quantization configuration in the reference neural network model corresponding to each of the at least one target neural network layers; and
update an original quantization configuration of at least one target neural network layer in the initial neural network model to the corresponding target quantization configuration, and maintain the quantization configurations of other initial neural network layers in the initial neural network model unchanged.

16. The electronic device of claim 11, wherein the one or more first processors are further configured to:
based on the determined quantization configuration and the training data set, train the initial neural network model with quantization perception to obtain a quantized pending neural network model;
if it is determined that the characteristic parameter deviation of at least one target characteristic after the pending neural network model processes test data in the training data set does not meet a training termination condition, continue to perform the quantization configuration update operation on the pending neural network model;
if it is determined that the characteristic parameter deviation of at least one target characteristic after the pending neural network model processes the test data in the training data set meets the training termination condition, determine the pending neural network model as the target neural network model.
